(19) United States
(12) Patent Application Publication
(10) Pub. No.: US 2012/0085071 A1
(43) Pub. Date: Apr. 12, 2012

(54) METHOD OF TREATING AT LEAST ONE CONTAINER IN A CONTAINER TREATMENT PLANT

(75) Inventors: Wolfgang Hahn, Neutraubling (DE); Konrad Senn, Regensburg (DE); Stefan Raith, Pfatter (DE); Frank Winzinger, Regensburg (DE); Jochen Forsthovel, Regensburg (DE); Markus Zolfl, Metten (DE); Bernd Sobiech, Regensburg (DE); Alexandra Donhauser, Regensburg (DE); Clemens Berger, Lappersdorf (DE); Josef Hausladen, Worth/Donau (DE)

(73) Assignee: KRONES AG, Neutraubling (DE)

(21) Appl. No.: 13/267,397

(22) Filed: Oct. 6, 2011

(30) Foreign Application Priority Data
Oct. 7, 2010 (DE) 10 2010 042 165.0

(51) Int. Cl. B65B 61/02; B65B 63/08; B67C 3/02; B67C 7/00; B65B 55/02; B65B 43/08

(52) U.S. Cl. 53/411; 53/425; 53/456; 53/467; 53/474; 53/440; 53/131.4; 53/561

(57) ABSTRACT

A method of treating at least one container in a container treatment plant, including marking at least one container with a marking, detecting the marking of the at least one container, selecting at least one container treatment machine of a container treatment plant and/or at least one operation setting of the at least one container treatment machine of the container treatment plant based on the detected marking, and treating the at least one container based on the selection of the at least one container treatment machine and/or the at least one operation setting.

### CROSS-REFERENCE TO RELATED APPLICATION

The present application claims the benefit of priority of German Application No. 102010042165.9, filed Oct. 7, 2010. The entire text of the priority application is incorporated herein by reference in its entirety.

### FIELD OF THE DISCLOSURE

The disclosure relates to a method of treating at least one container in a container treatment plant.

### BACKGROUND

In particular in the beverage industry, product packs with various products, for example different beverages, are often offered. For example, two bottles of orange juice, two bottles of currant juice and two bottles of water can be contained in one pack.

The different products are often offered in different containers, for example in plastic and/or glass bottles having different colors and/or different labels. For this, a container treatment plant, for example a bottling plant, must be adjusted to the product to be filled in and to the containers for the product to be filled in before production is started. The individual products are then filled in separate production cycles and finally commissioned to a mixed product pack.

One disadvantage of this method is that one cannot flexibly react to new requirements, for example new or additional production orders, and that between bottling of two different products, production must often be interrupted for manual reset works at the bottling plant.

### SUMMARY OF THE DISCLOSURE

It is therefore one aspect of the present disclosure to provide a more flexible method of treating at least one container in a container treatment plant.

The disclosure in particular provides a method of treating at least one container in a container treatment plant, including the steps of:

marking at least one container with a marking,

detecting the marking of the at least one container,

selecting at least one container treatment machine of the container treatment plant and/or at least one operation setting of at least one container treatment machine of the container treatment plant based on the detected marking, and

treating the at least one container based on the selection of the at least one container treatment machine and/or the at least one operation setting.

As in the method according to the disclosure, the at least one container is treated with a container treatment machine and/or an operation setting of the container treatment machine which was selected based on a marking of the container, the treatment of the at least one container can be configured to be more flexible in the container treatment plant. For example, a container can be in particular detected based on the marking and treated correspondingly.

If, for example, a certain container is to be filled with a certain product and/or provided with a certain label, this container can be correspondingly marked and then treated in the container treatment plant based on this marking. Production interruptions for changes to other container types and/or other products can thus be avoided or at least reduced.

A container can here in particular mean an object which comprises a hollow space which in particular serves the purpose of receiving a product and at least partially isolating it from the surrounding area. The at least one container can in particular be a container for a liquid, for example for a beverage.

The at least one container can in particular be a bottle. In particular, the at least one container can be a glass and/or a plastic bottle.

The at least one container can also correspond to a preform, in particular of thermoplastics, for a blow-molding machine.

In particular, a plurality of containers, in particular two or more containers, can be treated. The plurality of containers can comprise at least two different containers or container types. The plurality of containers can in particular comprise one or several glass and/or plastic bottles and/or one or several preforms.

“Container type” can here mean a type or sort of container, in particular having the same properties. In other words, two or more containers of one container type cannot be distinguished, or not be distinguished except for variations as to the production or machines. An exception can be here a marking, for example a number injected or blown into two containers, which stands for the cavity of the injection molding or blow molding machine and/or the production date of the container. Two containers of one container type can be still distinguished by this number.

The container treatment plant can comprise several, in particular two or more, container treatment machines, where in particular the containers to be treated in the container treatment plant can be conveyed from one container treatment machine to the next one via transport devices.

The container treatment plant can in particular be designed and/or configured such that in one production cycle, at least two containers can be treated in different ways, in particular wherein in one production cycle, at least two differently treated containers can be output from the container treatment plant.

The container treatment plant can in particular comprise at least one container treatment machine which comprises at least two different fitting parts. As an alternative or in addition, the container treatment plant can comprise at least one container treatment machine for which a control device of the container treatment plant can variably, in particular automatically, adjust at least one operating parameter.

The term “treatment” can here generally mean a manipulation of the at least one container. For example, during treatment, the at least one container can be changed as to its outer appearance, its filling and/or its spatial arrangement.

The container treatment plant can in particular comprise, as container treatment machines, a blow molding machine, an injection molding device for injection molding containers, in particular preforms, a filling device, a rinser, a sterilization device, a closer, a coating means, a container orientation device, a direct printing unit for labels and/or containers, a labeling device, a conveyor (a transport device), a packer, and/or a commissioning device (palletizer). In other words, the container treatment plant can be a bottling plant, in particular in the food industry, in particular in the beverage industry.

The filling device, the blow molding machine, the closer and/or the labeling device can be in particular configured as rotary machines.

The container treatment plant can moreover comprise a test or inspection device. The sterilization device can comprise a pasteurizer, in particular a tunnel pasteurizer, for sterilizing the already closed containers, but also other pasteurizers, such as short-time heating for products or the like.

The treatment of the at least one container can comprise blow molding, filling, cleaning, sterilizing, coating, closing, printing, labeling, packing and/or commissioning of the at least one container, and/or correspond to such a treatment.

The at least one operation setting of at least one container treatment machine can correspond to an adjustment or selection of an operating parameter or process parameter. An operation setting can also comprise an allocation of the container to a predetermined fitting part of a container treatment machine.

In other words, the at least one operation setting can correspond to a variable parameter which influences the treatment of the at least one container in the container treatment machine.

In case of a blow molding machine, in particular comprising a heating device for controlling the temperature of preforms, the at least one operation setting can be, for example, a blow pressure, a time for starting stretching or pulling out a stretching rod, a stretching speed, a rinsing angle within which the containers are in particular cooled by the stretching rod, a start for preblowing or final blowing, or a period for this, a recycling time within which blower air is recycled, a temperature profile to be adjusted, a distance between heaters, surface cooling and/or mouth cooling of the preforms in the heating device, and/or a temperature of the blow molds.

In case of a filling device, the at least one operation setting can be, for example, a selection of a product to be filled in, a desired filling volume, a filling temperature, a CO₂ dosing, a pressure application of the container before and/or during filling, stepwise or continuous pressure release after filling, and/or an amount of applied nitrogen.

In case of a closer (a closing device), the at least one operation setting can comprise, for example, a selection of a rotation speed, a number of rotations, a lifting and/or lowering motion, and/or a torque to be applied.

In case of a labeling device, the at least one operation setting can comprise, for example, a selection of one or several labels, a position of a label on a container, a shape and/or length of a label (for bottles of smaller diameters, a shorter roll-on label, for bottles of larger diameters, a longer label, for high bottles, a longer sleeve label; for short bottles, a shorter sleeve label), and/or speed control of a servo drive for rotating the container in the labeling device. On one roller for labels, different types of labels can also be alternately applied one after the other. If a bottle is ejected from the labeling machine due to a defect, the “gap” between the containers can then be closed by discharging a label from the roller.

In case of a sterilization device, the at least one operation setting can comprise, for example, a type and/or duration of sterilization.

The treatment of the at least one container can in particular be carried out with the at least one selected container treatment machine and/or using the at least one selected operation setting of the at least one container treatment machine.

The treatment step can in particular comprise feeding and/or introducing the at least one container to and/or into the at least one selected container treatment machine. This can be done, for example, by means of a distributing guide in the transport device of the container treatment machine.

As an alternative or in addition, the treatment step can comprise an adjustment of the at least one container treatment machine to the at least one selected operation setting.

Several container treatment machines of the container treatment plant can in particular be adjustable independently of each other. The at least one container treatment machine can in particular be designed and/or configured such that the adjustment to the at least one selected operation setting can be carried out without interrupting the operation.

The marking can be an electronic, a chemical and/or a physical marking. By means of the marking, the at least one container and/or the container type of the at least one container can be detected or identified.

The marking step can be carried out before and/or during the treatment of the at least one container in the container treatment plant, in particular before, after and/or during the introduction of the at least one container into the container treatment plant.

The marking step can be carried out after the treatment of the at least one container with one of the container treatment machines of the container treatment plant. For example, the at least one container can be marked after filling. By this, similar containers which are filled with different products can be, for example, distinguished in the further treatment processes, for example in labeling.

Electronic marking can here in particular mean a marking in terms of control. Electronic marking can be carried out, for example, by a control device of the container treatment plant. With an electronic marking, the at least one container itself can remain unchanged, in particular optically, physically and/or chemically unchanged.

An electronic marking of the at least one container can comprise an allocation of an identification number and/or an identification name to the at least one container, in particular by means of a control device of the container treatment plant. For example, the control device can allocate an identification number and/or an identification name to the at least one container, in particular in a storage cell of the control device, in particular temporarily.

In case of an electronic marking, the detection of the marking can in particular comprise a determination of a position of the at least one container, for example via video surveillance of the container treatment plant. As an alternative or in addition, the detection can in this case comprise tracking the at least one marked container in the container treatment plant by means of the control device of the container treatment plant.

A physical and/or chemical marking can here mean a marking which changes at least one physical and/or chemical property of the at least one container. For example, the physical and/or chemical marking can change the outer appearance of the at least one container. A chemical marking can be a different material additionally injected into the preform. If the preform is, for example, a PET (polyethylene terephthalate) preform, portions in and/or on its wall could be provided, in and/or after injection molding, with a different plastic (PE (polyethylene), HDPE (high density polyethylene), PP (polypropylene), PA (polyamide)), for example in an overmolding process.

The physical and/or chemical marking can in particular correspond to a marking of the at least one container. The marking can comprise, for example, a machine readable code, for example a bar code. The marking can be visible or invisible to the naked eye, for example by means of a substance which is only visible under ultraviolet light.

In case of a physical marking, the detection of the marking can comprise the detection of a marking with the aid of a sensor. The sensor can in particular be an optical sensor, for example a camera.

The marking can be printed onto the at least one container and/or be applied by means of laser inscription. As an alternative or in addition, the marking can comprise an element which is applied onto the at least one container, for example with an in-mold labeling process. This can be carried out with a device as it is described in US 2003/146549. The marking can comprise a label and/or an RFID chip which are temporarily or permanently fixed to the container.

If the at least one container is manufactured in a blow molding machine, the employed blow mold can generate a marking, for example a numbering, in the container wall during blow molding. In the process, the surface structure of the container can be changed. This can be carried out in a way similar to the method described in EP 1,331,077.

The marking can comprise, for example, one or several alphanumerical characters and/or one or several symbols.

A physical and/or chemical marking can be removed in particular before, during and/or directly after the container has been output from the container treatment plant.

The detection of the marking can be carried out by means of a sensor and/or a control device.

The detection of the marking can comprise a detection of the at least one container based on the marking.

A physical marking can also comprise an adjustment and/or change of the weight of the at least one container. The marking can in this case be detected by means of a weighing means, in particular in a filling device with a load cell for the empty container and/or the product to be filled in.

At least two containers can be marked with different markings, where the at least two containers are distinguished in the container treatment plant by means of the different markings, and wherein the at least two containers are, as a consequence of the distinction, treated differently in one or several container treatment machines of the container treatment plant, and/or are supplied to different container treatment machines. By this, containers can be treated differently in one production cycle in the container treatment plant in a simple and efficient manner.

The at least two containers can in particular be different or similar containers. In other words, the at least two containers can be of the same or of different container types.

The at least two containers can be output from the container treatment plant within one production cycle. “In one production cycle” means in this context that the at least two containers are output in one cycle, that means between the output of the first container and the second container, an operator does not have to manually reset the container treatment plant. In other words, a production cycle means a treatment of several containers without any standstill of the container treatment plant for resetting the container treatment plant.

The container treatment plant can in particular comprise for at least one treatment process at least two different container treatment machines, in particular wherein one of the at least two different container treatment machines is embodied and/or configured for treating a first container type, while a second one of the at least two different container treatment machines is embodied and/or configured for treating a second container type which in particular differs from the first one. For example, the container treatment plant can comprise at least two blow molding machines, filling devices, labeling devices, closers, packers, rinsers, sterilization devices, and/or commissioning devices, but also two different sources for containers.

The container treatment plant can be designed and/or configured such that a container can be selectively supplied to one of the at least two different container treatment machines for one treatment process. This can be achieved, for example, by means of a distributing guide of a transport device of the container treatment plant.

In particular, a first container with a first marking can be supplied to a first of the at least two different container treatment machines for a predetermined treatment process, while a second container with a second marking is supplied, for the predetermined treatment process, to a second container treatment machine of the at least two different container treatment machines which differs from the first container treatment machine.

The method can moreover comprise receiving an order and marking the at least one container based on the received order. The order can in particular be a commissioning order and/or a production order. The marking of the at least one container based on the order can in particular be effected during and/or directly after the blow molding of the container in a blow molding machine, during and/or directly after the manufacture of the container in an injection molding machine, and/or during and/or directly after the introduction of the container into the container treatment plant.

The method can moreover comprise modifying an order and marking the at least one container based on the modified order. If, for example, containers are discharged for quality control, or if they have to be discharged due to a defect, the order can be correspondingly modified to take into account the modifications. For example, in this case correspondingly more containers can be filled with a certain product to compensate the losses due to defects/quality control.

The at least one container treatment machine can comprise a blow molding machine, wherein a heating device of the blow molding machine, in particular a microwave heating device, is designed and/or configured such that at least two containers with different markings can be heated to different temperatures and/or temperature profiles.

The heating device can also comprise at least one heating chamber with infrared heating and/or laser heating. The heating device can comprise at least one heating chamber for individually heating a preform, in particular also for two or more preforms.

The at least one container treatment plant can comprise a blow molding machine, wherein at least two containers with different markings can be differently stretched by electric stretching in the blow molding machine, in particular in one production cycle. The output of the container treatment plant can be variably controlled.

In particular, the output, that means the speed at which the containers are treated, can be flexibly adapted to certain requirements. This can be in particular achieved by means of a heating for individual heating, for example a microwave heating device, in combination with an electric stretching of the preforms. The requirements can correspond, for example, to a change of a label roll or a readjustment of speed due to excessive foaming of carbonized products after filling and before closing. Speed can be adjusted on the basis of the detection of the marking. For example, larger containers can require longer filling periods. If a large container is detected, the speed of the filling device and/or the complete plant can be adapted.

One or several, in particular all, of the above mentioned procedure steps can be carried out partially or completely automatically or in an automated manner. One or several of the above mentioned procedure steps can also be carried out manually, in particular by emitting corresponding information to an operator. The information can, for example, comprise an automatically detected marking.

One or several, in particular all, of the above mentioned procedure steps can be carried out repeatedly, in particular for one or several, in particular for all, containers to be treated in the container treatment plant.

One or several, in particular all, of the above mentioned procedure steps can be carried out several times for at least one container, in particular repeatedly. In particular, the detection, the selection and/or the treatment can be carried out for several, in particular for each, container treatment process(es). In particular, detection and selection can be carried out before one or several, in particular before each, container treatment process(es). For this, in particular several devices for detecting the marking, for example sensors, can be provided.

The disclosure moreover provides a container treatment plant for treating at least one container, including:

a marking device for marking at least one container with a marking,

a device for detecting the marking of the at least one container, and

at least one container treatment machine for treating the at least one container,

where the container treatment plant is designed and/or configured such that at least one container treatment machine and/or at least one operation setting of the at least one container treatment machine are selected based on the marking of the at least one container.

In other words, the container treatment plant can be a container treatment plant for carrying out an above-mentioned method. So, the container treatment plant can in particular include one or several of the above-mentioned features.

The container treatment plant can in particular include a control device which is designed and/or configured such that it selects at least one container treatment machine and/or at least one operation setting of the at least one container treatment machine based on the marking of the at least one container.

The at least one container treatment machine can in particular include a blow molding machine, where the blow molding machine include a microwave heating device and/or an electric stretching device.

The container treatment plant can be a bottling plant, in particular in the beverage industry.

### BRIEF DESCRIPTION OF THE DRAWINGS

Further features and advantages of the disclosure will be illustrated below with reference to the exemplary figures. In the figures:

FIG. 1 shows an illustration of an exemplary method of treating at least one container;

FIG. 2 shows an exemplary container treatment plant for treating at least one container;

FIG. 3 shows another exemplary container treatment plant;

FIG. 4 shows another exemplary container treatment plant;

FIG. 5 shows another exemplary container treatment plant;

FIG. 6 shows another exemplary container treatment plant;

FIG. 7 shows another exemplary container treatment plant;

FIG. 8 shows another exemplary container treatment plant;

FIG. 9 shows another exemplary container treatment plant;

FIG. 10 shows another exemplary container treatment plant;

FIG. 11 shows another exemplary container treatment plant; and

FIG. 12 shows an exemplary blow molding station of an exemplary blow molding machine with a stretching device.

### DETAILED DESCRIPTION OF THE PREFERRED EMBODIMENT

In the following examples, it is assumed that the exemplary containers are preforms for blow molding machines and/or plastic bottles, in particular for beverages. However, other containers, for example glass bottles, bags or cans, are also conceivable.

In the examples, one or several products can be filled into at least two different container types. “Different” can in this context mean that the at least two container types differ in at least one chemical and/or physical property, and/or that the at least two container types differ in their outer appearance, for example in their labels, their allocated closure, their allocated sterilization, or their coating.

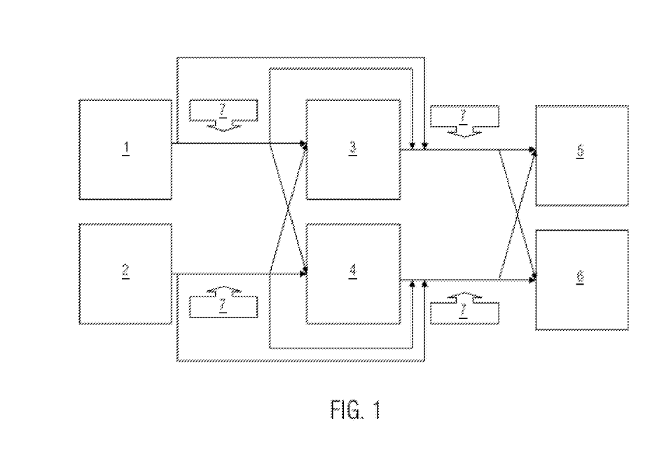

FIG. 1 illustrates an exemplary method of treating at least one container in a container treatment plant, in particular a bottling plant. Several container treatment machines 1, 2, 3, 4, 5 and 6 are provided. The exemplary container treatment machines 1 to 6 can comprise, for example, a blow molding machine, a sterilization device, a rinser, a filling device, a labeling device, a packing device and/or a palletizing or commissioning device. The exemplary container treatment machines 1 to 6 are interconnected by transport devices. In other words, at least one container in the exemplary bottling plant can be conveyed by means of a transport device from at least one container treatment machine to at least one further container treatment machine.

In the exemplary method of treating at least one container, at least one container is marked with a marking. This permits a correct treatment of the container, in particular by selecting, based on the marking, at least one container treatment machine of the bottling plant adapted to the container type, and/or by selecting at least one operation setting of at least one container treatment machine of the bottling plant corresponding to the container type.

For this, a device 7 for detecting the marking of the at least one container is provided in the region of several transport devices in the example of FIG. 1. The device 7 can be, for example, an optical sensor, in particular a camera. As an alternative, the device 7 can be a bar code scanner or an infrared sensor in case of a thermal marking.

After an exemplary container has been treated in the container treatment machine 1, it can be conveyed in the direction of the container treatment machine 3. By means of a device 7, a marking of the at least one container can be detected. Then, at least one operation setting of the container treatment machine 3 can be selected based on the detected marking. For example, the container treatment machine 3 can be a labeling device, wherein at least one label with which the at least one container is provided in the container treatment machine 3 is selected based on the marking. It would also be conceivable that the operation setting is the positioning of a label or the like.

As an alternative or in addition, at least one container treatment machine of the container treatment plant can be selected based on the detected marking. For example, the container treatment machines 3 and 4 can be a labeling device or individual labeling units of a labeling device, wherein the container treatment machine 3 is provided for labeling a first container type, while the container treatment machine 4 is provided for labeling a second container type that differs from the first container type. For example, the container treatment machine 3 can label the containers with a sleeve, and the container treatment machine 4 can label them with a wrap-around label, which is in particular “rolled on”.

Based on the marking detected by the device 7, one can detect whether the at least one container is a container of the first or the second container type. Thereupon, the at least one container can be correspondingly supplied either to the container treatment machine 3 or 4. As an alternative, a treatment can also be skipped, in particular if, for example, no labeling is required for a certain container type.

The marking of the container can be an electronic, physical, and/or chemical marking.

In case of an electronic marking, in contrast to the physical and/or chemical marking, the container is not changed as to its physical and/or chemical properties or its outer appearance. The electronic marking can be carried out by a control device and allocate an identification number or name to a container.

A physical and/or chemical marking of the containers can correspond to a sign. The sign can be visible or invisible to the naked eye, for example by means of a substance which is only visible under ultraviolet light.

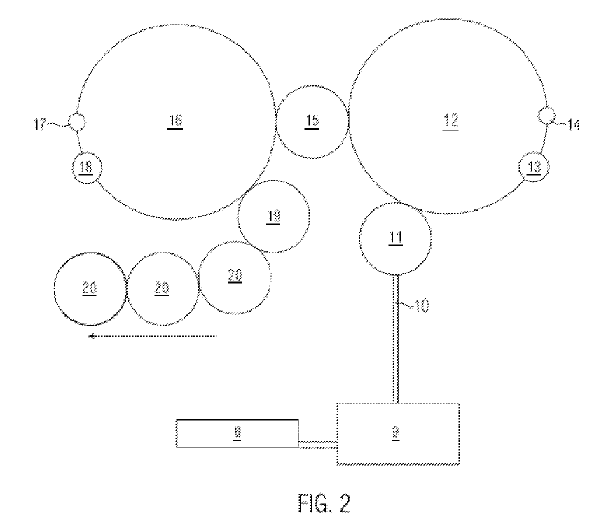

FIG. 2 shows an exemplary container treatment plant, in particular a part of a bottling plant for filling a container, for example a plastic bottle, with a beverage. The exemplary container treatment plant comprises a chute 8 in which preforms are stored. The preforms can comprise different preform types. The different preform types can be sorted in a sorting device 9 and then introduced into a heating device 12, in particular a microwave heating device, via a supply rail and a zigzag starwheel 11.

The heating device 12 can comprise at least two different heating chambers 13 and 14, wherein preforms are thermally conditioned in different ways in the heating chambers 13 and 14. For example, a first preform can be heated in the first heating chamber 13 to a temperature different from that of a second preform in the second heating chamber 14. The first preform can here in particular differ from the second preform, that means differ in at least one physical and/or chemical property. The first preform can in particular differ from the second preform in its outer appearance, for example in its geometric shape and/or size.

Further examples of a physical property can here be a diameter, in particular a neck diameter just above or underneath a supporting ring, a length, a type of thread for a closure, the fact whether a supporting ring is provided or not, or a color.

The at least two heating chambers 13, 14 for differently heating the preforms can also be of the same design, however treat the two different preforms differently. For example, the treatment of two preforms that must be treated differently can differ in that a duration of heating or introduced heat, a temperature profile in the longitudinal axis of the preform, and/or a temperature profile in the circumferential direction of the preform are selected to be different.

After thermal conditioning in the heating device 12, the preforms can be introduced into a blow molding machine 16 via a transfer means 15. The blow molding machine 16 can comprise at least two blow molding stations 17 and 18 in which preforms can be shaped to different plastic bottles.

The shaped plastic containers can then be supplied to a further container treatment machine, for example a filler, via a discharge starwheel 19 and one or several transfer starwheels 20.

A preform rinser and/or a preform sterilizer, in particular a linear or rotary rinser, can also be provided for the preforms. Different supply rails 10 for different preforms can also be provided. The sorting device 9 can be a roller sorter with different geometries or distances for preforms with different neck diameters.

With a vertical conveyor for the preforms, the distances between mountings for the preforms can vary.

The heating pins in the heating chambers 13 and 14 can have different diameters, heights, directions of stroke or orientations.

The transport clamps in the transfer means 15, 19, 20, but also in the other container treatment machines 11, 12, 16, can comprise different holding diameters or different orientations.

The heating device 12 can comprise shielding plates with different diameters that can vary depending on the winding zones of the preforms.

The infeed starwheel 11, in particular a zigzag starwheel, can be used for transporting different preforms.

Blow molds, bottoms and/or blow nozzles within the blow molding stations 17 and 18 can be embodied in different ways.

In the blow molding machine 16, at least two different stretch cams, bottom cams or mold support cams can be provided. The stretch stops can also be embodied in different ways for the at least two different blow molding stations 17 and 18.

The bottle's orientation downstream of the discharge starwheel 19 (and the support for it) can vary. Especially when square bottles are produced, these can be oriented. If round bottles are produced at the same time, they do not necessarily have to be oriented. At least two containers can also be oriented in different ways.

For at least one container, in the example of FIG. 2, at least one fitting part of the blow molding machine can be selected based on a marking of the at least one container. For example, the at least one container can be treated based on a detected marking of the at least one container either with the heating chamber 13 or the heating chamber 14, and/or either with the blow molding station 17 or with the blow molding station 18.

As an alternative or in addition, at least one operating parameter of the heating device 12 and/or the blow molding machine 16 can be adjusted based on the detected marking. For example, the temperature in the heating chamber 13 or 14, or the blow pressure in the blow molding station 17 or 18 can be selected based on the detected marking.

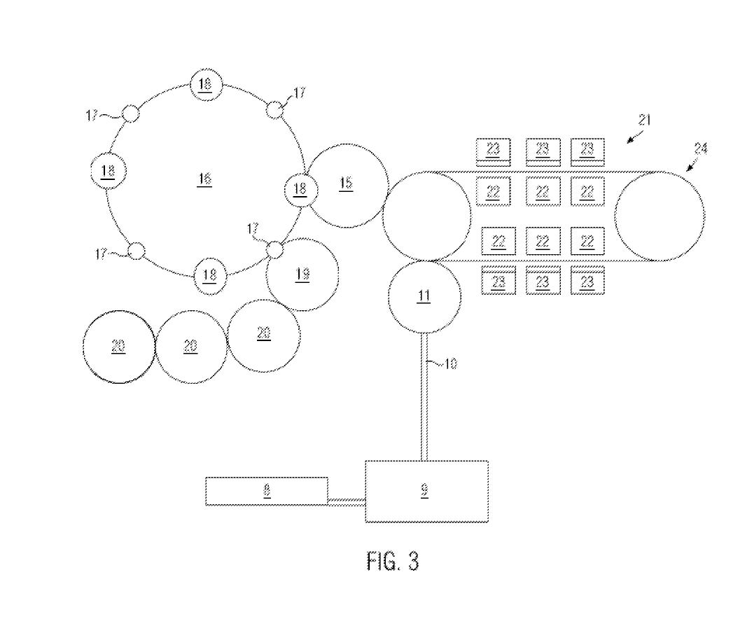

FIG. 3 shows another exemplary container treatment machine. Again, a part of a bottling plant is shown which comprises a heating device and a blow molding machine 16. In contrast to the example in FIG. 2, the heating device is embodied in this example as a linear oven 21. The linear oven 21 comprises a transport device 24 by means of which preforms can be conveyed through the linear oven 21. Moreover, several heating boxes 23 with infrared radiators and reflectors 22 opposite to them are provided.

The linear oven 21 can be designed and/or configured such that at least two preforms can be heated to different temperatures. In particular, at least one operation setting of the linear oven 21 can be selected based on a detected marking of a preform. For example, the speed of the transport device 24 can be adjusted based on the detected marking. As an alternative or in addition, the distance between a preform and the heating boxes 23 can be selected based on the detected marking. Further exemplary operation settings will be illustrated more in detail below.

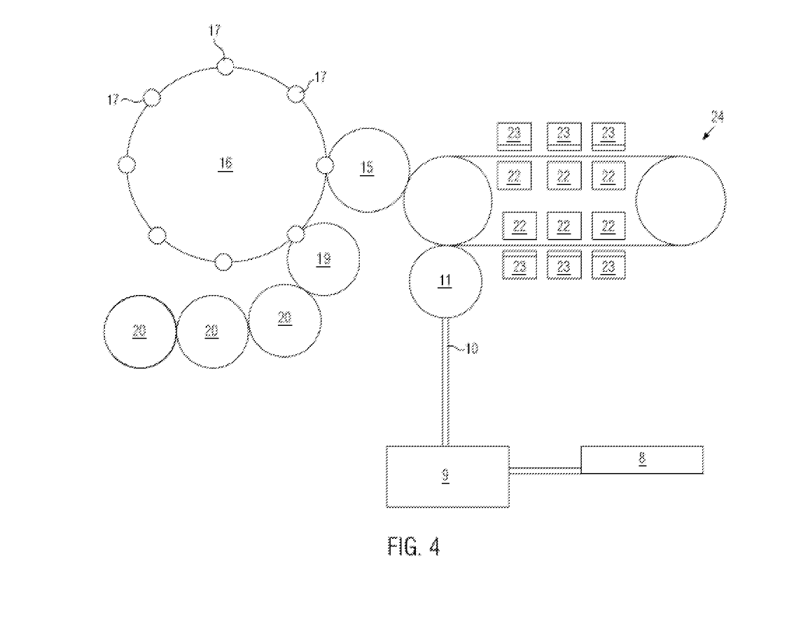

FIG. 4 shows a container treatment plant similar to that shown in FIG. 3, wherein the blow molding machine 16, however, only comprises one type of blow molding station 17. In this case, however, certain operation settings of the blow molding stations 17 can be selected based on a detected marking of a container, for example the used blow pressure or the like. The blow molding stations 17 and 18 of FIG. 2 can moreover comprise, for example, different blow molds. In particular, the embodiment shown in this figure is suited for containers of different colors which have the same shape after blowing, but differ in their colors. In particular, for the treatment of containers of different colors, a microwave oven can be used.

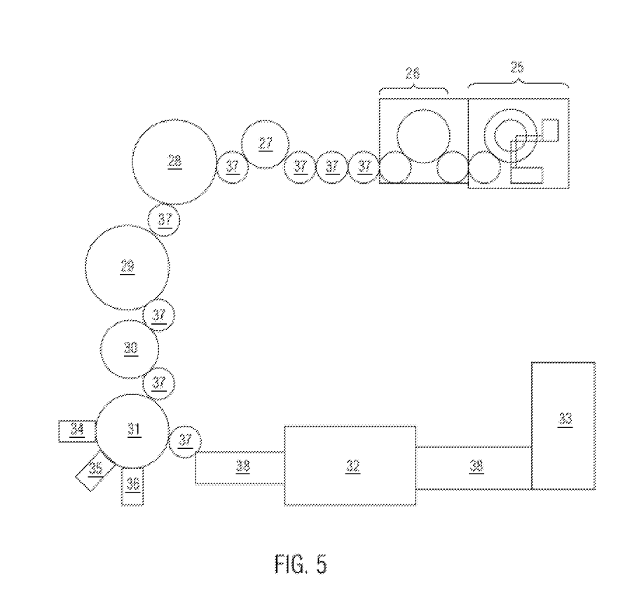

FIG. 5 shows another exemplary bottling plant, comprising an injection molding module 25 for producing preforms by injection molding, a blow molding machine 26, a sterilization device 27, a rinser 28, a filling device 29, a closer 30, a labeling device 31, a packer 32, and a palletizer 33. The individual treatment machines are in this case either interconnected by transfer starwheels 37 or by linear conveyors 38.

The blow molding machine 26 can in particular be a blow-molding unit, a heating device, a preform sterilization device (E-beam, electron beam) or hydrogen peroxide), and/or an extra module for profiling the temperature of a preform by means of temperature-controlled clamps coming into contact with the preform wall. In the extra module, a preform can be cooled in sections (at the points of contact). By this, the extra module can be suited to profile the preform in the circumferential direction (preferential heating).

In this example, a container, for example a preform or a plastic container made from a preform, can be provided with a marking. The marking can be a physical marking, for example by laser inscription, or an electronic marking by a control device of the bottling plant. Based on the marking, at least one operation setting of at least one of the container treatment machines can be selected. This in particular permits to distinguish at least between two containers with different markings by means of the different markings and to treat them on the basis of said distinction in one or several container treatment machines in different ways.

For example, in the filler 29, the product to be filled can be selected based on a detected marking. For this, the filler can be in particular designed such that it can fill at least two different products in one production cycle, that means without interrupting the operation for reset works.

The filler 29 can comprise, for example, a filling valve for mixing different beverage products. Such a filling valve is known, for example, from WO 2009/013523. By mixing different beverages, for example milk having different fat rates, at the valve, different beverages can be filled within one filling cycle, i.e. in one production cycle.

Different products can also be filled in one production cycle. For this, at least two vessels for different products can be arranged in the filler. If two different filling valves are required for filling in the two different products, different valves can also be arranged in the filler. The measuring method for determining the filling quantity and/or the filling height can also differ. Examples of different filling valves would be a long-tube filling valve and a short-tube filling valve.

The labeling device 31 can comprise several labeling units, in this example three labeling units 34, 35 and 36, which can be provided for applying different labels. Corresponding to a detected marking of at least one container, one of the labeling units 34 to 36 can be selected for labeling the at least one container.

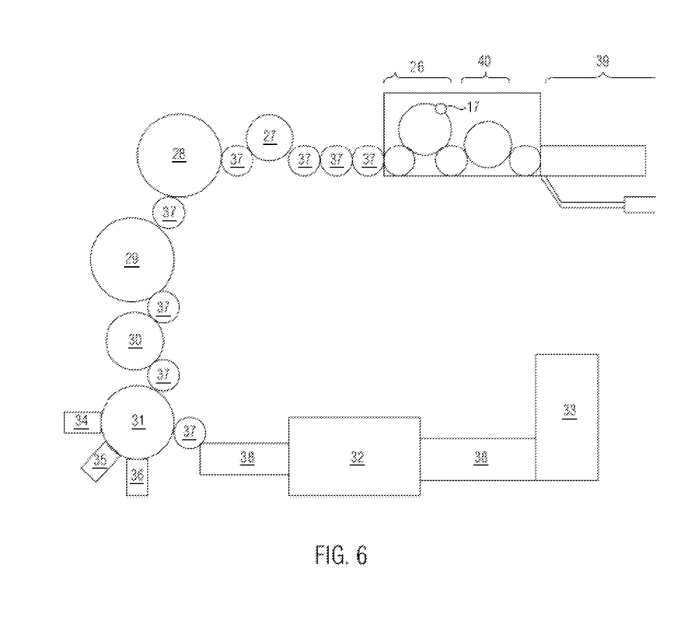

FIG. 6 shows another exemplary filling device. The filling device essentially corresponds to the exemplary filling device in FIG. 5, wherein instead of the injection molding module 25, a preform supply 39 with a corresponding heating device 40 is provided. So, this case involves a two-step method in which the preforms are first manufactured in a separate injection molding apparatus and then treated in the bottling plant.

Though it is not separately represented here, the shown bottling plant can comprise a device for detecting a marking upstream of one or of several, in particular all, container treatment machines. This can be a sensor, for example a camera. Based on the detected marking of a container, then at least one operation setting of at least one container treatment machine can be selected.

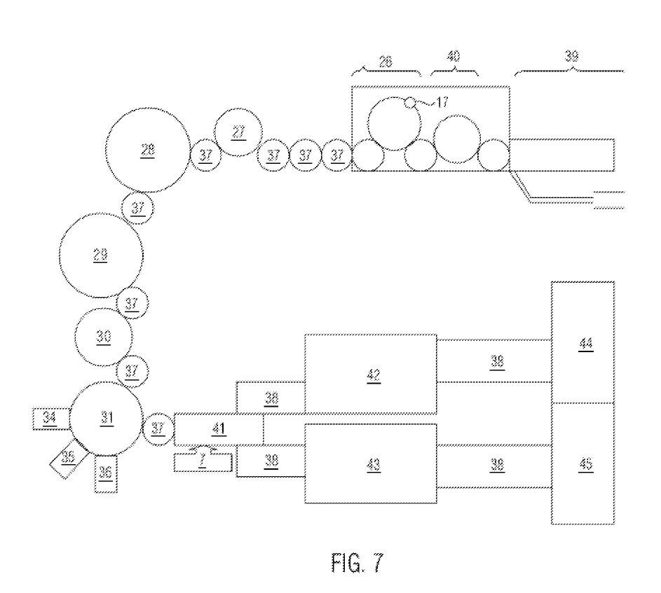

FIG. 7 shows another exemplary bottling plant. The bottling plant shown in FIG. 7 differs from the bottling plant of FIG. 6 in that downstream of the labeling device 31, there are provided a device 7 for detecting a marking of at least one container and a distributing guide 41 which allocates the at least one container to one of the two packers 42, 43, based on the detected marking. With one of the two linear transporters 38, the at least one container is then either supplied to the palletizer 44 or to the palletizer 45.

For example, one container with a first marking can be supplied to the first packer 42, while one container with a second marking differing from the first marking is supplied to the second packer 43. The containers can correspond, for example, to different products and/or different containers.

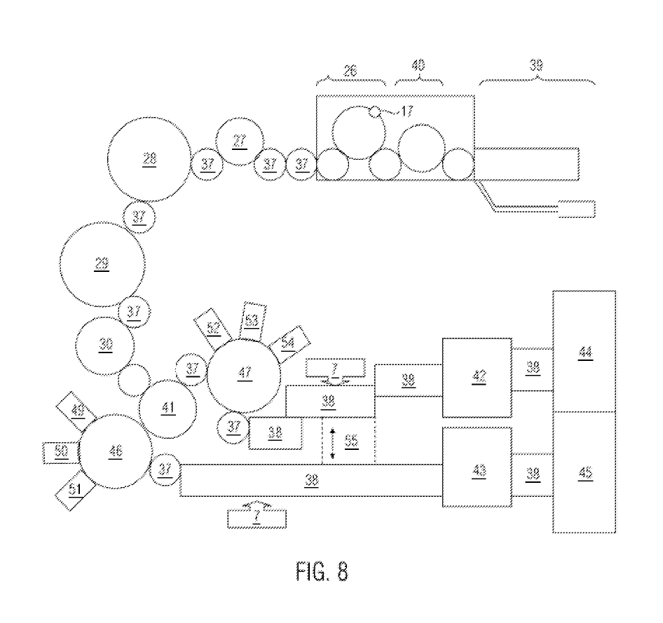

FIG. 8 shows another exemplary bottling plant. In this case, a first labeling device 46 and a second labeling device 47 are provided which each comprise three labeling units 49, 50, 51 or 52, 53, 54, respectively. A supply starwheel 48 selects one of the two labeling devices 46 or 47, based on a detected marking of at least one container. The first labeling device 46 can be provided, for example, for labeling a container filled with a first product, while the second labeling device 47 is provided for labeling containers which are filled with a second product. The supply starwheel 48 can be a starwheel as it is described, for example, in DE 10 2006 023 531.

In contrast to FIG. 7, the bottling plant in FIG. 8 moreover comprises one device 7 each for detecting a marking of a container which is disposed upstream of the packer 42 and 43, respectively. Based on the detected marking, a container labeled in the labeling device 47 can then be supplied either to the packer 42 and the palletizer 44, or, as an alternative, to the packer 43 and the palletizer 45. For this, an exchange device 55 is provided in addition which permits to supply a container labeled in the labeling device 47 to the packer 43 and the palletizer 45.

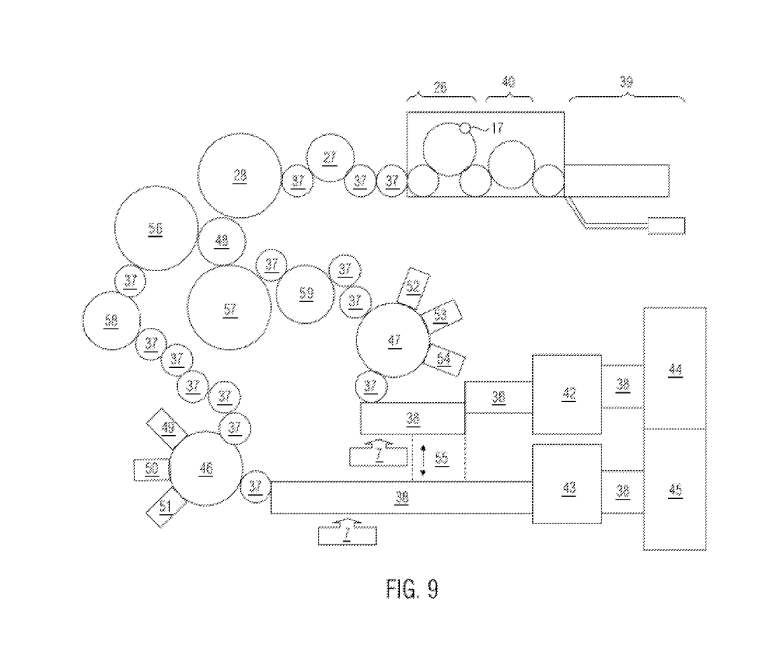

FIG. 9 shows another exemplary bottling plant. In this example, two fillers 56 and 57, and two closers 58 and 59, respectively, are also provided. A selection starwheel 48 supplies a container, based on a detected marking, either to the first filler 56 or to the second filler 57. The two fillers 56 and 57 can fill, for example, different products. The closers 58 and 59 can apply different closures onto the containers.

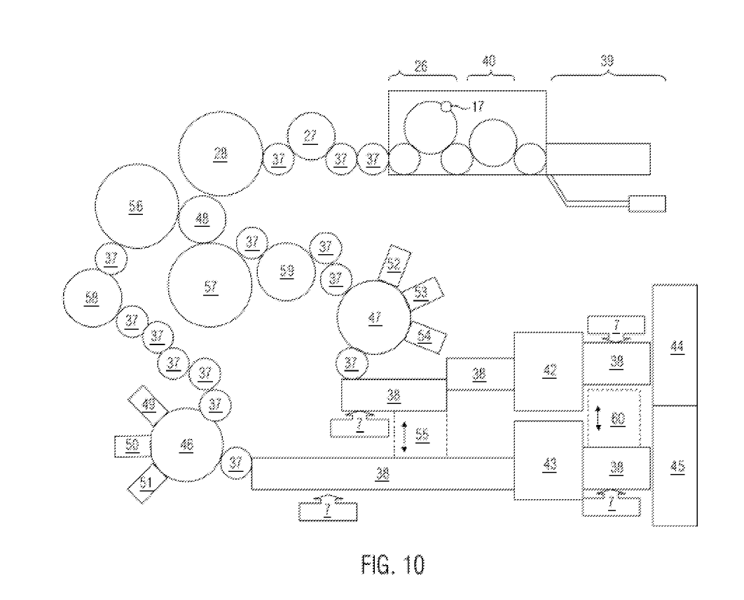

FIG. 10 shows another exemplary bottling plant. In addition to the elements shown in FIG. 9, one further device 7 each for detecting a marking of at least one container are provided upstream of the palletizer 44 or the palletizer 45, respectively. An additional exchange device 60 permits, based on the detected marking, to supply a container treated in the packer 42 either to the palletizer 44 or to the palletizer 45, or to allocate a container treated in the packer 43 either to the palletizer 44 or to the palletizer 45. A marking can also be the product itself or the closure itself, and/or it can be applied on the closure.

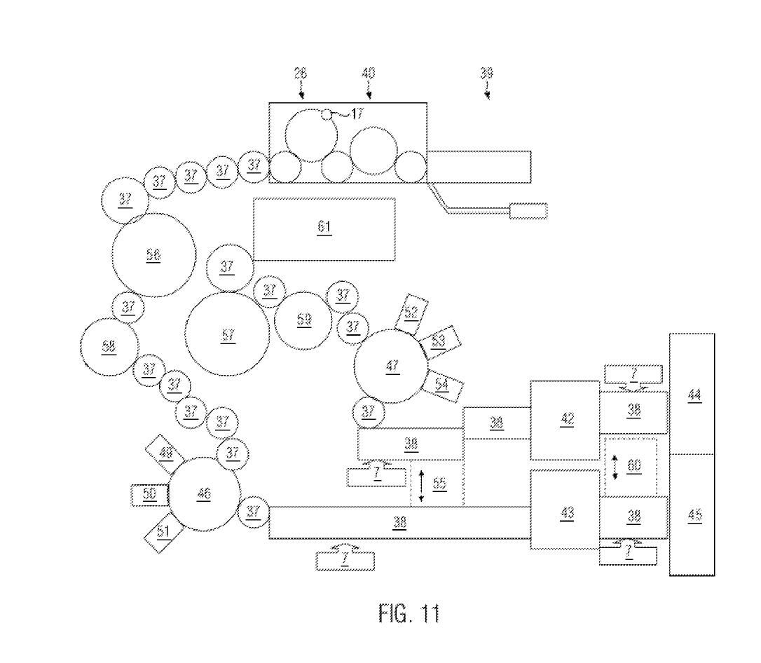

FIG. 11 shows another exemplary bottling plant. Here, next to the blow molding machine, an unscrambler 61 is additionally provided as an additional source for returnable containers to be sorted in and oriented, the unscramble 61 supplying containers to the filler 57. Between the unscrambler 61 and the filler 57, a (non-depicted) device for detecting a marking of the container can be provided. The sterilization device 27 and the rinser 28 are not shown in FIG. 11 for a better overview.

In this container treatment plant, pallets or packs which comprise returnable containers from the unscrambler 61 and non-returnable containers from the blow molding machine 26 can be output. Here, in particular the handling of the containers can differ, in particular depending on the marking.

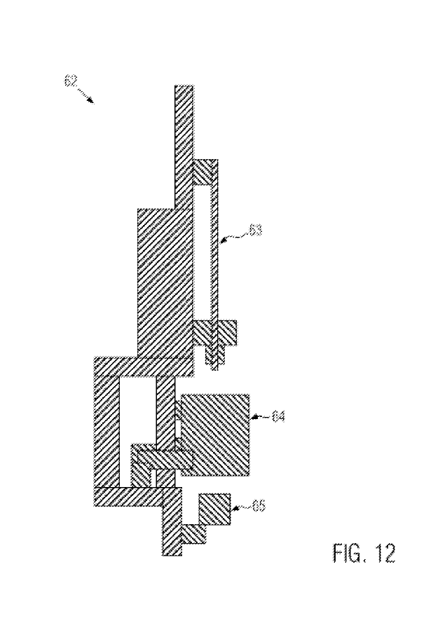

FIG. 12 shows an exemplary blow molding station 62 with a stretching device for stretching a preform in a blow molding machine. The exemplary stretching device comprises a stretching rod 63, a blow mold 64 and a blow mold bottom 65. The stretching device 62 can in particular be a stretching device which permits electric stretching, that means which permits a flexible control of the speed, the position and/or the time of the stretching rod 63 and/or profiles from combinations of speed, position and/or time.

In particular, a drive of the stretching rod 63 can be a linear drive or a servomotor, in particular with a common transmission of a rotary motion to a linear motion, for example by means of a threaded spindle.

The above-described bottling plants permit to flexibly treat containers based on a detected marking of the containers. In particular, at least two different formats can be processed in one production cycle. A “format” can here in particular mean a combination of a package and a product. The at least two different formats can differ in at least one physical or chemical parameter and/or comprise a different product.

Thus, several formats can be combined on one line. Here, combinations of different products, bottles, closures, labels, packs, or with different combinations of pallets are conceivable. For example, two different beverages can be filled in one filler. Subsequently, the containers can be provided with a marking corresponding to their filling. This can be an electronic marking, that means an allocation of an identification number or an identification name in a control device of the bottling plant. As an alternative or in addition, the bottles can be provided with a marking to identify them, for example by printing on, for example, a bar code and/or one or several alphanumeric characters with an inkjet printing device.

Before and/or during the introduction of the containers into a labeling machine, the marking can be detected by means of a sensor/a unit/a shift register/UV-light or the like, and the containers can be correspondingly labeled corresponding to the detected marking. This can be a direct label printing at the unit and/or at the bottle, and/or the selection of a corresponding unit of a labeling device.

The bottles can then be distributed to a required number of channels upstream of the packer. Here, the bottles can be distinguished again by detecting a marking.

If bottles are withdrawn from the bottling plant during production, for example for quality controls, an imbalance can occur in the preparation of the bottles to the packer. This imbalance can be removed by a signal to the filler by correspondingly filling more bottles of the withdrawn type in the filler, and analogously labeling them in the labeling machine and/or blow them in the blow molding machine. By this, an imbalance in the package can be avoided. Thus, one can also achieve a changeover to new charges within a very short time.

In the blow molding machine, different bottles can be manufactured simultaneously, in particular depending on the product type which is to be filled in. For example, four different colors for four different milk products, four different bottle designs for four different fat rates, or several different sizes/volumes/shapes and/or bottle weights can be manufactured. The manufactured containers can be provided with a physical marking, for example in the outlet of the blow molding machine, to be treated in the filler, the labeling machine and in the packer based on said marking.

As an alternative or in addition, it can be decided in the container treatment machines of the bottling plant which product is to be filled in and/or mixed by a valve, or to which valve the bottle is transferred when a product is permanently allocated to the valve. It can be determined in the labeling machine, based on the marking, which label is to be used, how the label is printed, for example which best before date and/or which company name and/or motif is printed on it, how the bottle is printed, or where the label is arranged on the bottle.

Moreover, the filling amount and/or the amount of CO₂ filled into the container can be determined.

As an alternative or in addition, one can decide, based on the marking, how and where the bottle is inspected (fill height, sterility, position of label and the like).

The containers can be marked by an in-mold labeling method, in particular by blowing the preform against a marking label, or by introducing an RFID chip (radio-frequency identification chip) into the blow mold which will adhere to the bottle. A direct print with a colorant visible under UV (ultraviolet) light is also possible. An adjustable, in particular automatically adjustable, bar code could also be blown into the bottle's wall in the blow mold. Such markings are also conceivable during and/or after the molding of a preform in an injection molding machine.

The bottling plant can also comprise buffer storages, in particular for different containers. One or several buffer storages can be arranged, in particular, upstream of a packer or filler.

One container can be supplied to at least one selected container treatment machine based on the detected marking. This can be done, for example, via a distributing guide. Such a distributing guide can be, for example, a servo distribution starwheel as it is described in DE 10 2006 023 531. As an alternative or in addition, distributing guides in air transport or base handling are also conceivable.

Marking can be effected, based on an order, in particular a production order, for the bottling plant. The order can specify at least one batch (combination of product, primary and secondary packaging). The bottling plant can then automatically activate and carry out the production order. Based on the marking, the bottling plant can automatically take the correct route in the processing of containers (routing). The production order can be a combination of several individual orders.

To permit to treat the at least one container based on the detected marking, at least one treatment machine can comprise different fitting parts, and/or at least one operation setting of at least one container treatment machine can be correspondingly selected. Below, there will be described different fitting parts and different operation settings for diverse container treatment machines which can be used to be able to variably treat containers in one production cycle based on a marking.

Differently shaped stretching rods for stretching preforms in a blow molding machine can be provided. The shape of the stretching rods can differ as to the diameter at the contact tip, the length and/or bores through which a fluid for cooling or blowing the container exits, in particular also the arrangement of the bores and/or the presence of bores. A container can be especially cooled during the blowing of containers to be filled in a hot state.

Different mandrel heights can be provided with different preform mouth piece heights or differently controlled immersion depths of the mandrels during transport, for example by a heating device of a blow molding machine.

In sterilization, different outputs of amounts of sterilization liquid and/or sterilization gas with differently high or differently wide/shaped containers/preforms can be provided. Different temperatures of the sterilization media can be selected. Different immersion depths/lances of different lengths can be provided.

Different distributions of the sterilization liquid in the bottle can be achieved by different openings in a nozzle. This can be electron beam fingers (E-beam fingers) and/or nozzles for ozone, gaseous or liquid H₂O₂ (hydrogen peroxide), peracetic acid or nozzles for rinsing with sterile water after sterilization. In addition or as an alternative, different treatment programs can be run for different container types in the sterilization.

During sterilization, differently long treatment periods can be in particular provided for different container types. For example, small containers can be sterilized only over 25° of a rotation of a rotating sterilization module, while larger bottles are sterilized over 100° or depending on time. This can be also done based on a signal from a detection means for detecting a marking. Thus, quite an amount of sterilization liquid or gas can be saved with the smaller containers.

Differently operated heating pockets can be provided in the heating device of a blow molding machine. For example, infrared lamps whose power can be controlled variably can be switched on.

Label dispensers can be provided with variable cutting lengths. One label roller can comprise two differently long labels in one line. As an alternative or in addition, printing can be done directly onto labels or onto the container. Analogously, printing onto packaging material for packs, such as six packs, boxes, pallets, can be accomplished. In this case, one can print, for example, onto a cardboard and/or a foil. Direct printing can also be used to mark a container, in particular a preform.

The same or different containers can be packed each into the same or different packages, variably in one or in several packers, in particular simultaneously.

Differently designed (contact) clamps can be provided in a heating device of a blow molding machine. By this, so-called “preferential heating” can be achieved, that means the manufacture of bottles of a constant wall thickness which are not rotationally symmetric in the circumferential direction. Here, clamps can be employed after the preforms have been heated, the clamps contacting the preforms at certain points of their outer walls just before they are blown to consequently cool or heat them at selective areas.

If different bottles are treated, different fitting parts can be provided for this. For example, two types of fittings can be provided, the one being rotationally symmetric and the other one not. In this case, it is also possible to only treat every second bottle. In this case, it is possible not to treat every second bottle, and for example run it past the preferential heating starwheel. This permits, for example, to consecutively output square bottles and round bottles from one blow molding machine.

Containers can be subjected to subsequent bottom cooling downstream of the blow molding machine for different periods. A bottle bottom can still contain a lot of heat directly after blow molding, in particular when it has a great wall thickness. It can be therefore necessary to additionally cool the bottom, in particular if the blow molding machine is arranged near the filling device. Here, nozzles are possible, among other things, which spray cold water and/or cold air from outside against the bottom, wherein the nozzles can be stationary or move along. In case of bottles which do not require any cooling, the supply of water and/or air can in this case be reduced or switched off.

In a sterilization device, different sterilization agents or sterilization media can be used, either in the same or in separate sterilization machines (for example H₂O₂ (liquid or gaseous), peracetic acid, caustic solution, hot water, steam, UV light, ozone gassing, electron beams and/or γ-radiation (gamma radiation)).

In a filling device, different volumes and/or products to be filled in can be filled in, in particular separately depending on the valve.

In a blow molding machine, too, different operation settings can be selected. For example, operation settings with the designations “Standard”, “Relax” and “Heatset” are known. With “Standard”, the blow molds are adjusted to be cold (4 to 20° C.) to quench the warm PET material after blowing and thus link the molecular chains. By this, high strength can be achieved. However, in hot filling, the bottle can be extremely deformed in the process. Therefore, the blow molds are heated in hot filling (110 to 140° C.), so that the PET “relaxes” at the blow mold's wall). Here, however, the bottles, having the same wall thickness, are not so stable.

In the “Heatset” process, after having contacted the hot mold, the bottle is rinsed by a hollow stretching rod, in particular compressed air is blown through it to bring out the heat. In the “Relax” process, the molds are heated to 60 to 80° C.

If at least two containers with different markings are to be treated differently, for example every second blow molding station could be run hot (heatset), and the other ones could be run cold (standard). By this, hot bottling could be achieved for every second bottle, and cold bottling for the other ones. The filling process could be performed on two different fillers or in one filling device, wherein different filling valves are supplied either with hot or with cold product. By back-shrinking in hot filling, the bottle could be deformed by the arising vacuum (hot product cools down later and density is reduced). Therefore, liquid nitrogen can be introduced into the product before the bottle is closed, the nitrogen compensating this vacuum. In this case, a nitrogen nozzle could be provided for the filling valves, wherein a sensor detects the temperature of the product in the bottle and introduces or not nitrogen based on this detected temperature. As an alternative or in addition, one can decide, based on the detected marking whether nitrogen is introduced into the bottle or not. Nitrogen can also be injected in a separate starwheel before and/or after filling.

Different transport paths are conceivable in air transport, in particular in case of different neck diameters.

For a blow molding machine, for example the following process parameters can be selected for the operation setting: distances between heaters, surface cooling of a preform in the heating device, mouth cooling of the preform in a heating device, and/or the temperature of the blow molds. An employed radiation wavelength can also be changed, for example by an optional employment of optical filters.

The following process parameters can be selected as operation setting in a filling device: the filling temperature of the product, CO₂ dosage, pressure application (or vacuum) of the bottle before, during and/or after filling, sterilization, the product itself and/or nitrogen application.

The following process parameters can be selected, for example, as operation settings in a labeling machine: speed regulation of the servo drive (adaption to new angles to be rotated), changeable mandrel in the sleeve, correct apparatuses present/switched on, correct labels inserted.

The marking can also be used to diagnose occurring problems in the container treatment plant. For example, by the marking, relations between errors and/or problems in the container treatment plant with the batch to be produced can be determined. In particular in case of microbiological errors, the traceability according to stations and parameters can be of great interest when looking for causes.

The following different fitting parts are conceivable for the container treatment machines:

Blow Molding Machine Fittings:

stretching rods of different diameters or lengths, having different tips, for example normally round in one case, while the stretching rods for the second fitting have a petaloidal shape to cool certain areas of the preforms to a greater extent at the contact points. The latter is required, for example, in nitrogen hotfill (see above: nitrogen application);

lances in preform rinsers (linear or rotary rinsers) and transport holders for them which blow out the preforms preferably with ionized compressed air, here, the length, angle or diameter can vary;

supply rails or sorting means, in particular roller sorters having different geometries or distances;

distance of mountings from a vertical conveyor for preforms;

heating pins having different diameters, heights, strokes, active or passive grippers, or orientations;

transport clamps having different holding diameters or orientations;

shielding plates having different diameters which can vary depending on the mouth region of the preforms;

infeed starwheel (zigzag starwheel) for transporting preforms within the heating device of a blow molding machine;

blow molds, bottoms; blow nozzles within one blow molding station;

two different stretch cams, bottom cams or mold support control cams for the opening movement;

stretch stops;

bottle orientation downstream of the discharge starwheel (and support for it). In the production of square bottles, these can be oriented. If round bottles are produced simultaneously, they do not necessarily have to be oriented. Two different orientations are also conceivable; and/or

supply points (hotfill: heat-resistant pipes for oil, cooled mold: standard pipes), and material for the blow molds (hotfill: for example steel, cooled mold: for example aluminum).

Filling Module:

two classification starwheels or worms for different bottle diameters or neck diameters;

two different neck handling clamps, neck handling clamp starwheels (in case of a simultaneous change of several clamps which are mounted on a starwheel, pocket neck handling starwheels (with bulgings having different diameters);

also including container guides (in particular rails);

container guides in base handling (depending on the bottle diameter), for this - outside guides and starwheels themselves;

sensors or sensor positions for the bottle, container detection, filling level control, temperature, moisture on the bottle;

bottle spraying systems and/or thread spraying means to remove product residues after filling and/or closing;

rinser, closer or filler clamps or mountings (handling, neck diameter);

lowering starwheel (height and diameter of the bottle);

protective chamber sheets in the filler;

clamp starwheel which grips the bottles at their body (also depending on the diameter);

two different filling valves, bottom pieces, centering bells, spacers, return air and filling tubes, different sensors for determining the filling amount or filling height (flow-through, load cell, electric probes);

dosing chambers (one valve with, the other one without);

two different closers;

closing cones and heads and channels;

device for classifying the closures (pick & place disk or station);

towing shoe, closure transfer;

different closing tools (for screw caps, crown caps, champagne corks or cork lock or snap-on element, heads for roll-on closures, sealing films);

downstream of the lowering starwheel, two different outlet transport belts;

CIP (cleaning in place) caps (different diameters or heights, depending on the filling valve);

Labeling Module:

outlet latch;

guide curve, machine inlet; guide curve, machine outlet;

infeed starwheel; latch for infeed starwheel;

locking starwheel;

classification worms;

inlet guide, external and internal;

transfer worms;

braking roller for foiling;

grippers and mountings: base gripper; tilting gripper; centering bell; label gripper; bottle gripper (neck handling gripper, base plate); gripper cylinder; mounting mandrels; sliding gripper;

label dispenser and slide for it;

gluing rollers; glue (hot-setting adhesive, cold-setting adhesive);

control tape guides;

glue scrapers;

label strippers;

glue segment support;

label brush application (diameter, height, hardness);

rolling-on;

compartments (for an exact guidance of the bottle in the inlet/outlet of the labeling module);

sponge roller at the conveying belt (for pressing on the label, variation in distance and diameter, depending on the bottle's diameter);

table cam segment (cam segment for controlling the bottle's rotation, vs. servo);

Packaging Module:

classification strips;

expansion wedges in case of dual tracks;

connecting rods with a different machine division;

wrapping rods;

multi- or complete-layered packing and palletizing gripper heads of all kinds;

series packing and palletizing gripper heads of all kinds;

separating plates for clamping grippers;

guide plates for the bottle table;

covers for dust protection;

insertion frames for packing containers;

different pallets.

Test or Inspection Means

guide rails;

bottle grippers.

Pasteurizer for Pasteurizing Products

gripper and conveyors of any kind

It will be understood that features mentioned in the above described embodiments are not restricted to these special combinations and are also possible in any other combinations.

It is in general also possible to arrange the corresponding fittings on a treatment machine in sections or in an alternating manner. Here, not only two sets of fittings per treatment machine are possible, but also three, four, five or more.

Here, the treatment machines can in particular be embodied as rotary machines and comprise the different fittings, or manners of treatment (operation settings, see above) alternating at the periphery and distributed at regular distances.

In particular, a treatment machine can consist only of different fittings for each treatment unit. In other words, no fitting would be then present twice on one treatment machine.

A treatment step can also be omitted depending on the container detected on the basis of the marking, it can in particular be bypassed with a distributing guide or a distribution starwheel.

1. Method of treating at least one container in a container treatment plant, comprising:
marking at least one container with a marking;
detecting the marking of the at least one container;
selecting at least one container treatment machine of the container treatment plant and/or at least one operation setting of at least one container treatment machine of the container treatment plant based on the detected marking; and
treating the at least one container based on the selection of the at least one container treatment machine and/or the at least one operation setting.

2. The method according to claim 1, wherein the marking is one of an electronic marking, a physical marking, a chemical marking, and a combination thereof.

3. The method according to claim 2, wherein an electronic marking of the at least one container comprises an allocation of one of an identification number, an identification name or combination thereof to the at least one container.

4. The method according to claim 2, wherein a physical marking, chemical marking, or combination thereof of the at least one container comprises applying a marking on a surface of the container, in a container wall, and a combination thereof.

5. The method according to claim 4, wherein the marking is one of printed onto the at least one container and/or applied by laser inscription, and a combination thereof.

6. The method according to claim 4, wherein the marking comprises an element which is applied onto the at least one container.

7. The method according to claim 1, wherein detecting the marking is carried out by means of one of a sensor, a control device, and a combination thereof.

8. The method according to claim 1, wherein at least two containers are marked with different markings, where the at least two containers are distinguished in the container treatment plant by means of the different markings, and wherein the at least two containers one of are treated differently in one or several container treatment machines of the container treatment plant, are supplied to different container treatment machines on the basis of the distinction, and a combination thereof.

9. The method according to claim 8, wherein the at least two containers are output from the container treatment plant within one production cycle.

10. The method according to claim 1, receiving an order and marking the at least one container based on the received order.

11. The method according to claim 1, wherein the at least one container treatment machine comprises one of a blow molding machine, an injection molding device for injection-molding containers, a filling device, a rinser, a sterilizer, a closer, a coating means, a container orientation device, a direct print unit for labels and/or containers, a labeling device, a conveyor, a commissioning device, a packer, and a combination thereof.

12. The method according to claim 1, wherein the at least one container treatment machine comprises a blow molding machine, and wherein a heating device of the blow molding is designed and/or configured such that at least two containers with different markings are heated to one of different temperatures, different temperature profiles, and a combination thereof.

13. The method according to claim 11, wherein the at least one container treatment machine comprises a blow molding machine, and wherein at least two containers with different markings are differently stretched in the blow molding machine by electric stretching.

14. Container treatment plant for treating at least one container, comprising:
a marking device for marking at least one container with a marking;
a device for detecting the marking of the at least one container; and
at least one container treatment machine for treating the at least one container;
wherein the container treatment plant is designed and/or configured such that one of at least one container treatment machine, at least one operation setting, and a combination thereof of the at least one container treatment machine are selected based on the marking of the at least one container.

15. The container treatment plant according to claim 14, wherein the at least one container treatment machine comprises one of a blow molding machine, a filling device, a labeling device, a packer, and a combination thereof.

16. The method according to claim 3, wherein the allocation is by means of a control device of the container treatment plant.

17. The method according to claim 6, wherein application of the element comprises an in-mold labeling method.

18. The method according to claim 6, wherein the marking comprises one of a label, an RFID chip, and a combination thereof.

19. The method according to claim 11, wherein the containers are performs.

20. The method according to claim 12, wherein the heating device is a microwave heating device.

21. The container treatment plant according to claim 15, and wherein the at least one container treatment machine comprises a blow molding machine comprising one of a microwave heating device, an electric stretching device, and a combination thereof.
